(19) United States
(12) Patent Application Publication
(10) Pub. No.: US 2006/0191781 A1
(43) Pub. Date: Aug. 31, 2006

(54) Apparatus and method for manufacturing nono carbon

(76) Inventors: Takeshi Azami, Tokyo (JP); Sumio Iijima, Tokyo (JP); Masako Yudasaka, Tokyo (JP); Daisuke Kasuya, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/568,386

(22) PCT Filed: Aug. 5, 2004
(86) PCT No.: PCT/JP04/11263

§ 371 Date: Apr. 4, 2006

(30) Foreign Application Priority Data
Aug. 20, 2003 (JP) 2003-296227

(51) Int. Cl. D01F 9/12; C01B 31/00; B01J 19/08

(52) U.S. Cl. 204/157.47; 423/447.1; 977/844; 422/186

(57) ABSTRACT

An apparatus for manufacturing nano-carbon including a laser source (111) which irradiates light to a surface of a graphite rod (101) and a nano-carbon recovery chamber (119) which recovers carbon vapor as nano-carbon, evaporated from the graphite rod (101) by irradiating light, has a contact surface being in contact with the surface of the graphite rod (101) and a holding roller (131) which movably holds the graphite rod (101) by frictional force generated between the contact surface and the surface of the graphite rod (101). The graphite rod (101) rotates and moves by the frictional force generated between the contact surface of the holding roller (131) and the surface of the graphite rod (101), thereby driving the holding roller (131) so that an irradiation position of the light irradiated to the surface of the graphite rod (101) covers over almost the entire area of the surface of the graphite rod (101).

### TECHNICAL FIELD

The present invention relates to an apparatus for manufacturing nano-carbon and a method of manufacturing nano-carbon.

### BACKGROUND ART

In recent years, technological application of nano-carbon has been actively examined. Nano-carbon means a carbon substance having a nanoscale fine structure typified by a carbon nano-tube, carbon nano-horn, or the like. Of these substances, a carbon nano-horn has a tubular body structure in which a carbon nano-tube cylindrically rounded with graphite sheets has one end having a cone shape and application to various technical fields is expected from its unique characteristics. Generally, a carbon nano-horn forms carbon nano horn assemblies in which a cone part gathers centering around a tube in a form protruding to the surface like a horn by Van der Waals force acting between cone parts.

It is reported that carbon nano horn assemblies are manufactured by the laser evaporation method by which a laser beam is irradiated to a carbon substance of material (appropriately referred to as a graphite target below) under an inert gas atmosphere (patent document 1). [Patent document 1] Japanese Laid-open patent publication No. 2001-64004

### DISCLOSURE OF THE INVENTION

However, in a general design of a known apparatus for manufacturing nano-carbon, a part which grasps a graphite target is required. For this reason, a laser beam cannot be irradiated to that part and therefore the entire surface of the graphite target cannot be used. Consequently, there is a problem in that use efficiency of the graphite target decreases and productivity of the nano-carbon reduces.

The present invention has been made in view of the above-described circumstances, and an object of the present invention is to provide a manufacturing method and manufacturing apparatus which enhance productivity of carbon nano horn assemblies and are suitable for mass production manufacturing. Furthermore, another object of the present invention is to provide a manufacturing method and manufacturing apparatus which enhance productivity of nano-carbon and are suitable for mass production manufacturing.

According to the present invention, there is provided an apparatus for manufacturing nano-carbon, including: a target holding unit which has a contact surface being in contact with a surface of a graphite target and movably holds the graphite target by frictional force generated between the contact surface and the surface of the graphite target; a light source which irradiates light to the surface of the graphite target; a moving unit which drives the target holding unit so as to move the graphite target held by the a target holding unit relatively to the light source, to move an irradiation position of the light on the surface of the graphite target, and to move the graphite target by the frictional force generated between the contact surface and the surface of the graphite target; and a recovery unit which recovers nano-carbon obtained from the light irradiation.

Furthermore, according to the present invention, there is provided a method of manufacturing nano-carbon, including: irradiating light to a surface of a graphite target; and recovering nano-carbon generated in the irradiating light, wherein the irradiating light includes irradiating the light while holding the graphite target by a contact surface disposed in contact with the surface while moving the graphite target by frictional force between the surface and the contact surface.

According to the present invention, a part which grasps the graphite target is not required, ablation can be performed to the entire surface of the graphite target, and nano-carbon can be readily mass-produced.

According to the present invention, there is provided an apparatus for manufacturing nano-carbon, including: a target holding unit which has a contact surface being in contact with a surface of a cylindrical graphite target and movably holds the graphite target by frictional force generated between the contact surface and the surface of the graphite target; a light source which irradiates light to the surface of the graphite target; a moving unit which drives the target holding unit so as to move the graphite target held by the target holding unit relatively to the light source, to move an irradiation position of the light on the surface of the graphite target, and to rotate the graphite target around a central axis thereof by the frictional force generated between the contact surface and the surface of the graphite target; and a recovery unit which recovers nano-carbon obtained from the light irradiation.

Furthermore, according to the present invention, there is provided a method of manufacturing nano-carbon, including: irradiating light to a surface of a cylindrical graphite target while rotating the graphite target around a central axis; and recovering nano-carbon generated in the irradiating light, wherein the irradiating light includes irradiating the light while holding the graphite target by a contact surface disposed in contact with the surface while rotating the graphite target around the central axis by frictional force between the surface and the contact surface.

According to the present invention, a part which grasps the graphite target is not required, ablation can be performed to the entire surface of the graphite target, and nano-carbon can be continuously readily mass-produced by performing light irradiation while rotating the cylindrical graphite target.

In addition, in the present invention, a “central axis” means a horizontal axis in a length direction, passing through the cross-sectional center perpendicular to the length direction of the cylindrical graphite target. Furthermore, for example, a graphite rod may be used as the cylindrical graphite target. Here, a “graphite rod” means a graphite target formed in a rod shape. If a rod shaped one is used, either hollow or solid shape is no object. Further, it is preferable that the surface of the cylindrical graphite target to be irradiated by light is a side surface of the cylindrical graphite target. Here, a “side surface of cylindrical graphite target” indicates a rounded surface parallel to the length direction of the cylinder.

In the apparatus for manufacturing nano-carbon of the present invention, the target holding unit may have two cylindrical rollers which have rotation axes substantially parallel to the central axis of the graphite target and hold the graphite target between positions parallely disposed each other; and the moving unit may rotate the graphite target around the central axis by the frictional force generated between the contact surface of the roller and the surface of the graphite target by rotating the roller around the rotation axis.

According to this configuration, with a simple structure, ablation can be performed to the entire surface of the graphite target, and nano-carbon can be continuously readily mass-produced by performing light irradiation while rotating the cylindrical graphite target.

In the apparatus for manufacturing nano-carbon of the present invention, the moving unit may drive the target holding unit so that the irradiation position of the light irradiated to the surface of the graphite target covers over almost the entire area of the surface of the graphite target.

Furthermore, in the method of manufacturing nano-carbon of the present invention, in the irradiating light to the surface of the graphite target, the light may be irradiated so as to cover over almost the entire area of the surface of the graphite target while moving the irradiation position of the light.

This enables to use up the graphite target and therefore productivity of nano-carbon may be further improved.

In the apparatus for manufacturing nano-carbon of the present invention, the moving unit may be configured so as to move the irradiation position while maintaining an irradiation angle of the light substantially constant at the irradiation position of the light on the surface of the graphite target.

Furthermore, in the method of manufacturing nano-carbon the present invention, in the irradiating light, the light may be irradiated so that the irradiation angle of the light to the surface of the graphite target is substantially constant.

This enables to irradiate light to the surface of the graphite target at a substantially constant irradiation angle while continuously supplying the graphite target at the irradiation position of the light. Consequently, wobbling of power density of light to be irradiated to the surface of the graphite target may be surely suppressed. Therefore, nano-carbon with stable quality may be mass-produced.

In addition, in this specification, an “irradiation angle” means an angle formed by light and a vertical line to the surface of the graphite target at the irradiation position of the light.

Further, irradiating light so that the irradiation angle of the light to the surface of the graphite target becomes substantially constant means that constantness of the irradiation angle is maintained to the extent that power density of the light to be irradiated to the surface of the graphite target does not intentionally fluctuate.

In the method of manufacturing nano-carbon of the present invention, the contact surface may be disposed in contact with a side surface of the graphite target. This enables to stably hold the cylindrical graphite target and to stably rotate in its central axis direction. Therefore, nano-carbon with stable quality may be mass-produced with high productivity.

In the apparatus for manufacturing nano-carbon of the present invention, the target holding unit may include one of stainless steel or ceramics, alternatively a metal deposited with carbon on a surface thereof.

According to this configuration, in the heat resistance condition, the surface of the graphite target may not be damaged while generating appropriate friction between the graphite target and the roller of the target holding unit.

In the method of manufacturing nano-carbon of the present invention, the irradiating light may include irradiating a laser beam.

This enables the light wavelength and direction to be constant, whereby the light irradiation condition to the surface of the graphite target may be accurately controlled. Therefore, desirable nano-carbon may be selectively produced.

In the apparatus for manufacturing nano-carbon of the present invention, the nano-carbon may be carbon nano horn assemblies.

Furthermore, in the method of manufacturing nano-carbon of the present invention, the recovering nano-carbon may include recovering carbon nano horn assemblies.

This enables to efficiently perform mass synthesis of carbon nano horn assemblies. In the present invention, a carbon nano-horn constituting carbon nano horn assemblies may be a single layer carbon nano-horn or multi-layer carbon nano-horn.

Further, the nano-carbon may be a carbon nano-tube.

In the present invention, the moving unit may adopt a mode in which, for example, the irradiation position in the length direction of the graphite target is moved when the light is irradiated while rotating the cylindrical graphite target around the central axis; and also the graphite target is moved in an upward direction perpendicular to the central axis of the graphite target when the graphite target is cut by the light irradiation and the diameter decreases. According to this configuration, the light irradiation condition to the graphite target may be accurately controlled during the movement of the graphite target and therefore desirable nano-carbon may be selectively manufactured.

According to the present invention as described above, the light is irradiated to the surface of the graphite target while holding the graphite target by a contact surface disposed in contact with the surface of the graphite target and while moving the graphite target by frictional force between the surface and the contact surface; whereby there may be provided a manufacturing method and manufacturing apparatus which enhance productivity of carbon nano horn assemblies and are suitable for mass production manufacturing. Furthermore, according to the present invention, there may be provided a manufacturing method and manufacturing apparatus which enhance productivity of nano-carbon and are suitable for mass production manufacturing.

### BRIEF DESCRIPTION OF THE DRAWINGS

The aforementioned objects and other objects, features and advantages will become clear from the following description of the preferred embodiments and the accompanying drawings.

FIG. 1 is a perspective view showing a configuration example of an apparatus for manufacturing nano-carbon according to an embodiment of the present invention.

FIG. 2 is a partial cross-sectional view showing an example of a target holding unit of the apparatus for manufacturing nano-carbon shown in FIG. 1.

FIG. 3 is a partial cross-sectional view showing an example of the target holding unit of the apparatus for manufacturing nano-carbon shown in FIG. 1.

FIG. 4 is a view for explaining rotation of a graphite rod at a target holding movable unit shown in FIG. 2.

FIG. 5 is a partial front view showing an example of an up and down movable part of the target holding unit shown in FIG. 2.

FIG. 6 is a view for explaining position movement of a graphite rod at the target holding unit shown in FIG. 2.

FIG. 7 is a partial cross-sectional view showing an example of a target holding unit of the apparatus for manufacturing nano-carbon shown in FIG. 1.

FIG. 8 is a view for explaining rotation of a graphite rod at a target holding movable unit shown in FIG. 7.

FIG. 9 is a view for explaining position movement of a graphite rod at the target holding movable unit shown in FIG. 7.

### BEST MODE FOR CARRYING OUT THE INVENTION

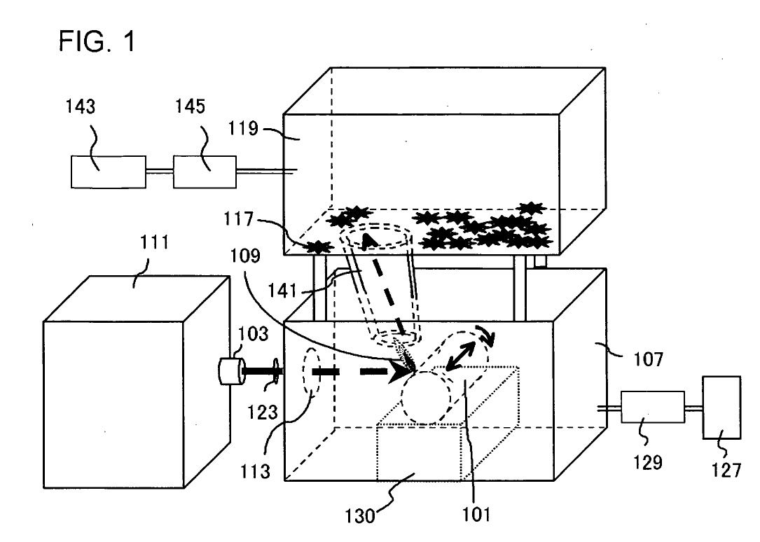

Referring to the drawings, preferred embodiments of an apparatus for and a method of manufacturing nano-carbon according to the present invention will be described below through the case where nano-carbon is carbon nano horn assemblies as an example. In addition, FIG. 1 and drawings used for explaining other manufacturing apparatus are schematic drawings and size of each constitutional member does not necessarily correspond to an actual dimensional ratio.

FIG. 1 is a view showing a configuration example of an apparatus for manufacturing nano-carbon according to an embodiment of the present invention. The manufacturing apparatus of this embodiment includes a laser source 111 which irradiates a laser beam 103 to the surface of a graphite rod 101, a condensing lens 123 for a laser beam 103, a target holding movable unit 130 which rotatably and movably holds the graphite rod 101, a manufacturing chamber 107 which accommodates the target holding movable unit 130 and manufactures nano-carbon by irradiating the laser beam 103 from the laser source 111 to the graphite rod 101 through a laser beam window 113, a carrier pipe 141 disposed in a generating direction of a flame called as a plume 109 which is generated when the laser beam 103 is irradiated from the laser source 111 to a side surface of the graphite rod 101, and a nano-carbon recovery chamber 119 which communicates to the manufacturing chamber 107 via a carrier pipe 141 and recovers carbon vapor evaporated from the graphite rod 101 as a nano-carbon. In this embodiment, nano-carbon to be recovered includes carbon nano horn assemblies 117.

Further, the manufacturing chamber 107 is connected to an inert gas supply unit 127 via a flowmeter 129.

Here, the carrier pipe 141 is disposed in the generating direction of the plume 109 when the laser beam 103 is irradiated from the laser source 111 to the surface of the graphite rod 101. In FIG. 1, since the laser beam 103 is irradiated at an angle of 45° formed to the surface of the graphite rod 101, the plume 109 is generated in a direction perpendicular to the surface of the graphite rod 101. Then, the carrier pipe 141 is configured so that its length direction is arranged in a direction perpendicular to the surface of the graphite rod 101. This enables the produced carbon nano horn assemblies 117 to be surely recovered to the nano-carbon recovery chamber 119.

Furthermore, the manufacturing chamber 107 is configured so that the laser beam 103 is irradiated to a side surface of the graphite rod 101 while rotating the graphite rod 101 in the circumferential direction, as to be described later. The laser beam 103 is irradiated in the position relationship in which the direction of the laser beam 103 does not conform to the generating direction of the plume 109. This enables an angle of the plume 109 generated at the side surface of the graphite rod 101 to be preliminarily predicted. Therefore, the position and angle of the carrier pipe 141 can be accurately controlled. Consequently, the carbon nano horn assemblies 117 can be efficiently manufactured and surely recovered.

In this embodiment, a cylindrical graphite rod 101 is used as a solid carbon element substance which is a target to be irradiated by the laser beam 103.

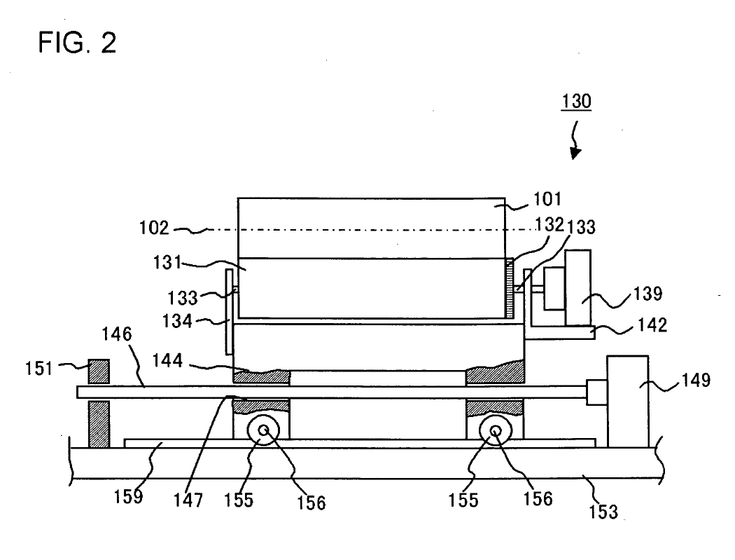

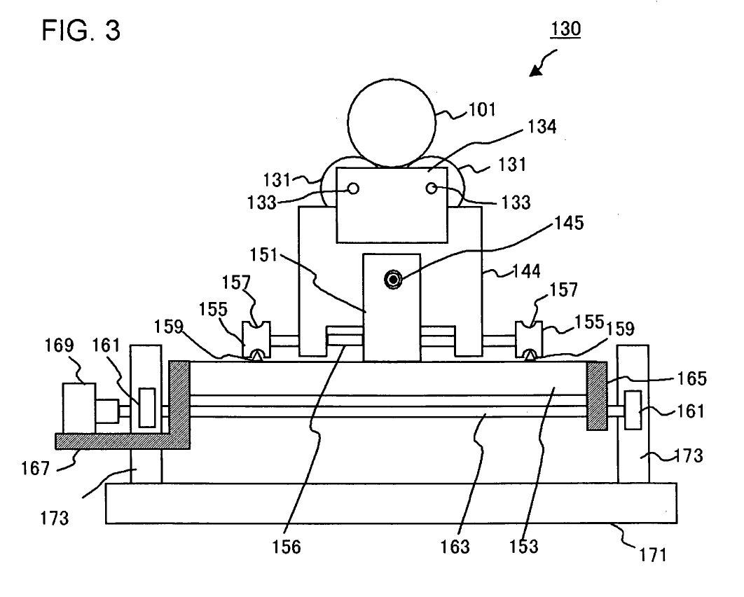

FIG. 2 is a partial cross-sectional view, seen from the right side in FIG. 1, which shows an example of the target holding movable unit 130 of the apparatus for manufacturing nano-carbon shown in FIG. 1. FIG. 3 is a partial cross-sectional view, seen from the front side in FIG. 1, which shows the target holding movable unit 130 shown in FIG. 1. Here, FIG. 2 and FIG. 3 show a state where the graphite rod 101 is mounted on the target holding movable unit 130.

As shown in FIG. 2 and FIG. 3, the target holding movable unit 130 has a contact surface which is in contact with the side surface of the graphite rod 101 and includes two holding rollers 131 which rotatably holds the graphite rod 101 by frictional force generated between the contact surface and the side surface of the graphite rod 101, and a movable table 144 which moves in a direction substantially parallel to a rotation axis 133 of the holding roller 131.

The holding roller 131 includes one of stainless steel or ceramics, alternatively a metal deposited with carbon on its surface. More specifically, in the case of stainless steel, rough surfaced stainless steel is preferable. This enables the surface of the graphite rod 101 not to be damaged while generating appropriating frictional force between the surface of the graphite rod 101 and the contact surface.

An interlocking tooth 132 is formed on one end of each holding roller 131. The interlocking tooth 132 is formed so as not to come in contact with the side surface of the graphite rod 101. Each holding roller 131 has a rotation axis 133 disposed substantially parallel to a central axis 102 of the graphite rod 101 and a motor 139 which rotates each holding roller 131 via the rotation axis 133 of each holding roller 131. The graphite rod 101 is held between positions that the rotation axes 133 of two holding rollers 131 are substantially parallely disposed each other. Both ends of the rotation axis 133 of the holding roller 131 are rotatably fixed to the movable table 144 by a rotation axis retainer 134 and a rotation axis retainer 142. Furthermore, the motor 139 is fixed on the rotation axis retainer 142.

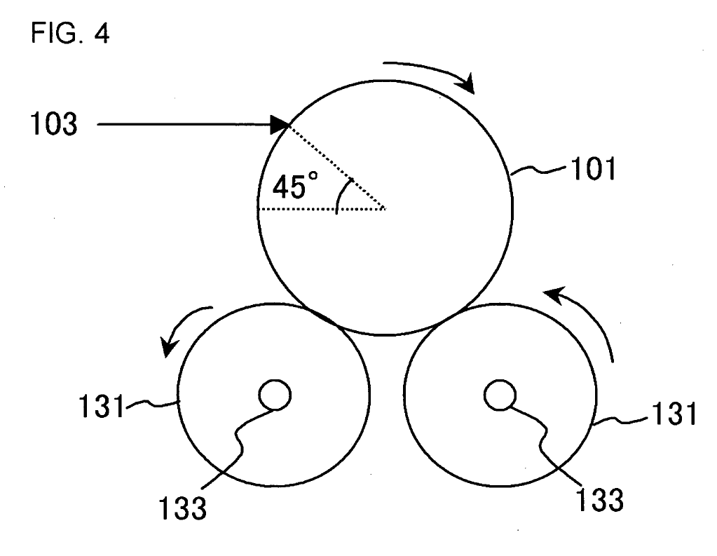

The thus configured target holding movable unit 130 rotates the holding roller 131 by the motor 139 around the rotation axis 133. FIG. 4 is a view for explaining rotation of the graphite rod 101 at the target holding movable unit 130 shown in FIG. 2.

FIG. 4 is a view, seen from a cross-section perpendicular to the length direction, which shows two cylindrical holding rollers 131 and the cylindrical graphite rod 101. Two holding rollers 131 are parallely disposed and the graphite rod 101 is held therebetween. Frictional force is generated between the contact surface of the holding roller 131 and the side surface of the graphite rod 101 at the contact surface being in contact with the graphite rod 101. The graphite rod 101 can be reversely rotated by frictional force generated by rotating the holding roller 131. In this way, a mechanism which holds the graphite rod 101 at the contact surface and rotates the graphite rod 101 along the central axis 102 is independently provided, thereby stably holding the graphite rod 101 and well controllably rotating.

Referring back to FIG. 2 and FIG. 3, tapped holes 147 are formed on the lower side of the movable table 144 in a direction substantially parallel to the rotation axis 133 of the holding roller 131. The target holding movable unit 130 further includes a feed screw rod 146 which is inserted into the tapped holes 147 to interlock and moves the movable table 144 by being rotated, a motor 149 which rotates the feed screw rod 146 around the axial direction, and a feed screw retainer 151 which rotatably fixes both ends of the feed screw rod 146 to a rail support base 153.

An axle 156 is rotatably disposed at the lower end of the movable table 144 and wheels 155 are rotatably provided on both sides of the axle 156 to move in a direction substantially parallel to the rotation axis 133 of the holding roller 131 mounted on the movable table 144. Each wheel 155 has a groove 157 formed at the circumferential center.

The target holding movable unit 130 includes the rail support base 153 and rails 159 which extend on the rail support base 153 in a direction substantially parallel to the rotation axes 133 of the holding rollers 131 and engage to the grooves 157 of the wheels 155 for the movable table 144.

In this embodiment, thus configured target holding movable unit 130 enables to move in a direction substantially parallel to the central axis 102 of the graphite rod 101 by rotating the motor 149. A moving unit which moves the graphite rod 101 in a long axis direction is not limited to this configuration, but it is also possible to use other units.

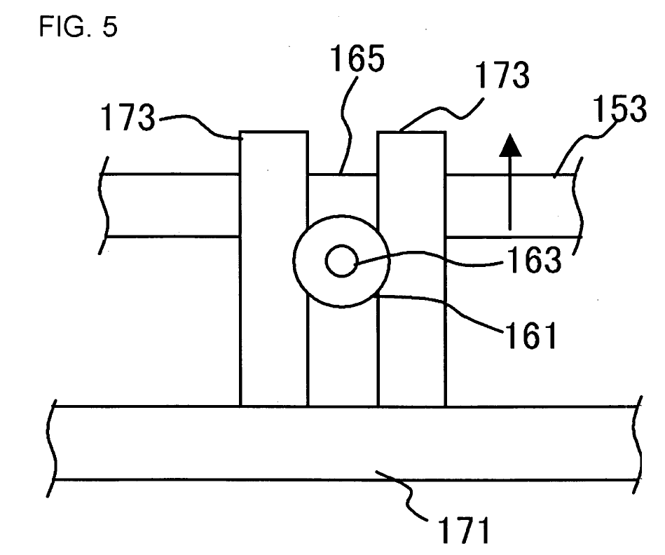

FIG. 5 is a partial front view showing an example of an up and down movable part of the target holding unit 130 shown in FIG. 2. The up and down movable parts of the target holding movable unit 130 shown in FIG. 5 are arranged at four corners of the rail support base 153 of the target holding movable unit 130. As shown in FIG. 3 and FIG. 5, the up and down movable part of the target holding movable unit 130 includes a base 171; racks 173 disposed perpendicular to the surface of the base 171; gears 161, each of which meshes with an interlocking tooth formed on the rack 173 and moves up and down between the racks 173 with rotation; a rotation axis 163 for the gears 161; a rotation axis retainer 165 and rotation axis retainer 167 which rotatably fix the rotation axis 163 to the rail support base 153; and a motor 169 which is placed at one end of the rotation axis 163 and rotates the gears 161 around the rotation axis 163 via the rotation axis 163.

In this embodiment, thus configured target holding movable unit 130 rotates the gears 161 by the motor 169 and moves the rail support base 153 up and down by moving the gears 161 up and down while meshing with the racks 173. A moving unit which moves the graphite rod 101 in a vertically upward direction is not limited to this configuration, but it is also possible to use other units.

The target holding movable unit 130 has the motor 139 which rotates the graphite rod 101 around the central axis, the motor 149 which moves in the direction parallel to the central axis, and the motor 169 which moves in up and down direction; and these motors operate as independent driving mechanisms, thereby surely holding the graphite rod 101 and well controllably moving the graphite rod 101 in each direction.

In addition, although not specifically shown in the drawings, this embodiment includes a control unit which controls the rotation of each motor 139, motor 149, and motor 169. The control unit may be an operation unit which manually controls each motor or a computer or the like which automatically controls each motor.

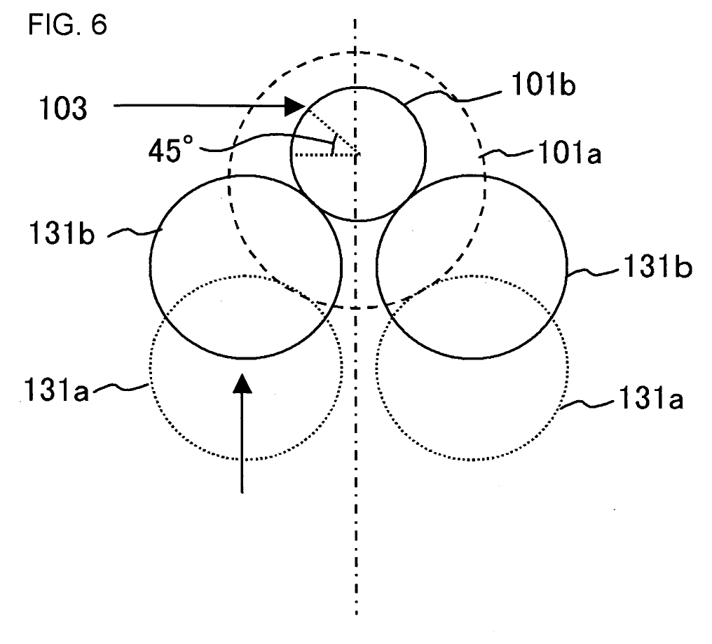

In the manufacturing apparatus of this embodiment, the position of the laser source 111 is fixed to the manufacturing chamber 107. Referring to FIG. 4 and FIG. 6, position movement in the vertical direction of the graphite rod 101 will be described below. FIG. 6 is a view for explaining position movement of the graphite rod 101 at the target holding unit 130 shown in FIG. 2.

FIG. 4 is a cross-section perpendicular to the central axis 102, showing the graphite rod 101 before performing light irradiation; and FIG. 6 is a cross-section perpendicular to the central axis 102, showing the graphite rod 101 whose cross-section diameter reduces by performing light irradiation.

As shown in FIG. 4, the laser beam 103 is irradiated so that an irradiation angle is constant. The laser beam 103 can be continuously irradiated at a constant power density in the length direction of the graphite rod 101 by sliding the graphite rod 101 in its length direction while maintaining the irradiation angle of the laser beam 103 constant.

In addition, “power density” shown in this specification means power density of light actually irradiated to the surface of the graphite target, that is, it means power density at the light irradiation part of the surface of the graphite target.

In the case where a cylindrical graphite target is used, the irradiation angle is an angle which is formed by a line segment that connects the irradiation position and the center of the circle and the horizontal plane at a cross-section perpendicular to the length direction of the graphite rod 101. In this embodiment, in order to suppress generation of returned light and stably manufacture the carbon nano horn assemblies 117 with high purity, it is preferable to set the irradiation angle to be not less than 30 degrees to not more than 60 degrees.

The irradiation angle is set to be not less than 30 degrees, thereby enabling to suppress generation of the returned light due to reflecting the irradiating laser beam 103. Furthermore, it can prevent the generated plume 109 from directly impinging to the lens 123 through the laser beam window 113. For this reason, it is effective to protect the lens 123 and to prevent the carbon nano horn assemblies 117 from adhering to the laser beam window 113. Consequently, the power density of the light to be irradiated to the graphite rod 101 can be stabilized and the carbon nano horn assemblies 117 can be stably manufactured with a high yield constant.

Furthermore, the laser beam 103 is irradiated at not more than 60 degrees, thereby enabling to suppress generation of amorphous carbon and to improve a rate of the carbon nano horn assemblies 117 in the product, that is, a yield constant of the carbon nano horn assemblies 117 can be improved. Further, it is particularly preferable to set the irradiation angle to be 45 degrees. The rate of the carbon nano horn assemblies 117 in the product can be further improved by irradiating at 45 degrees.

In addition, since it is configured to irradiate the laser beam 103 to the side surface of the graphite rod 101, change may be readily made by changing the irradiation angle to the side surface in a state where the position of the lens 123 is fixed. Therefore, the power density can be changeable and surely adjustable. For example, in the case where the position of the lens 123 is fixed, if the irradiation angle is set to be 30 degrees, for example, the power density can be increased. Furthermore, for example, if the irradiation angle is set to be 60 degrees, the power density can be controlled to be lowered.

Further, the graphite rod 101 is cut by light irradiation and its diameter decreases. FIG. 6 shows this process. In order to maintain the irradiation angle of the laser beam 103 constant, the holding roller 131 needs to be moved in a vertically upward direction to the central axis 102 of the graphite rod 101. As shown in FIG. 6, the irradiation angle of the laser beam 103 to be irradiated to the graphite rod 101 can be maintained constant by moving the holding roller 131.

In this way, the graphite rod 101 can rotate around the central axis 102 by frictional force generated between the contact surface of the holding roller 131 and the surface of the graphite rod 101 and can also move in a long axis direction and a vertically upward direction while maintaining the irradiation angle of the laser beam 103 constant, whereby the irradiation position of the laser beam 103 can cover over almost the entire area of the side surface of the graphite rod 101.

In addition, “the irradiation position of the laser beam 103 covers over almost the entire area of the side surface of the graphite rod 101” means that it may be acceptable if it is possible to produce carbon vapor over the entire area of the side surface of the graphite rod 101. The entire of the graphite rod 101 can be used as a material of the carbon nano horn assemblies 117 by providing a configuration capable of generating carbon vapor over the entire side surface of the graphite rod 101, thereby suppressing an unused region to be generated in the graphite rod 101, whereby the material can be efficiently used.

As described above, in the apparatus for manufacturing nano-carbon of this embodiment, a part which grasps the graphite target 101 is not required and light irradiation is performed over the entire area of the surface of the graphite rod 101 by continuously changing the part of the laser beam 103 to be irradiated to the side surface of the cylindrical graphite rod 101 and by rotating the irradiation part; and therefore, the carbon nano horn assemblies 117 can be continuously readily mass-produced. Furthermore, since the graphite rod 101, which is a graphite target, can be repeatedly irradiated by the laser beam 103, the graphite rod 101 can be effectively used.

Next, a manufacturing method of the carbon nano horn assemblies 117 using the manufacturing apparatus of this embodiment will be described below.

In the manufacturing apparatus of this embodiment, high purity graphite such as round bar sintered carbon, compression molded carbon may be used as the graphite rod 101.

Furthermore, for example, a laser beam such as high output CO₂ gas laser beam is used as the laser beam 103.

The laser beam 103 is irradiated to the graphite rod 101 under an atmosphere of reactive inert gas including rare gas such as Ar, He, for example, under an atmosphere at a pressure of not less than 10³ Pa to not more than 10⁵ Pa. Furthermore, it is preferable to be an inert gas atmosphere after the inside of the manufacturing chamber 107 is preliminarily exhausted by depressurizing at a pressure of not more than 10⁻² Pa, for example, with a vacuum pump 143 to which a pressure gauge 145 is connected.

In addition, it is preferable to adjust an output, spot diameter, and irradiation angle of the laser beam 103 so that power density of the laser beam 103 at the side surface of the graphite rod 101 is maintained almost constant, for example, to be not less than 5 kw/cm² to not more than 25 kw/cm².

The output of the laser beam 103 is set to be not less than 1 kW to not more than 50 kW, for example. Furthermore, a pulse width of the laser beam 103 is set to be not less than 0.5 sec, preferably not less than 0.75 sec. This enables accumulated energy of the laser beam 103 irradiated to the surface of the graphite rod 101 to be sufficiently ensured. Therefore, the carbon nano horn assemblies 117 can be efficiently manufactured. Further, a pulse width of the laser beam 103 is set to be not more than 1.5 sec, for example, preferably not more than 1.25 sec. This heats the surface of the graphite rod 101 excessively, thereby fluctuating energy density of the surface, whereby lowering of the yield constant of the carbon nano horn assemblies 117 can be suppressed. It is further preferable to set the pulse width of the laser beam 103 to be not less than 0.75 sec to not more than 1 sec. This improves both formation rate and yield constant of the carbon nano horn assemblies 117.

Furthermore, an intermission width at the irradiation of the laser beam 103 may be set to be not less than 0.1 sec, preferably to be not less than 0.25 sec. This more surely suppress the surface of the graphite rod 101 to be excessively heated.

For example, a preferable irradiation angle of the laser beam 103 is described with reference to FIG. 4 and FIG. 6. A spot diameter to the side surface of the graphite rod 101 in irradiating the laser beam 103 may be set to be not less than 0.5 mm to not more than 5 mm, for example.

Furthermore, it is preferable to set the spot of the laser beam 103 to be moved at a velocity (linear velocity) of not less than 0.01 mm/sec to not more than 55 mm/sec. For example, in the case where the laser beam 103 is irradiated to the surface of a graphite target having a diameter of 100 mm, the aforementioned linear velocity (peripheral velocity) can be realized if a rotation speed is set to be, for example, not less than 0.01 rpm to not more than 10 rpm when the graphite rod 101 having a diameter of 100 mm is rotated in a circumferential direction at a constant speed by the target holding movable unit 130. Furthermore, it is preferable that if the rotation speed is set to be not less than 2 rpm to not more than 6 rpm, the yield constant of the carbon nano horn assemblies 117 may be further improved.

In addition, a rotation direction of the graphite rod 101 is not limited; however, it is preferable to be rotated in a direction that the irradiation position recedes from the laser beam 103, that is, it is preferable to be rotated in the direction headed to the carrier pipe 141 from the laser beam 103 as indicated by the arrows in FIG. 1. This enables the carbon nano horn assemblies 117 to be more surely recovered.

In the apparatus shown in FIG. 1, soot like substances obtained by the irradiation of the laser beam 103 are recovered in the nano-carbon recovery chamber 119; however, the soot like substances may be recovered by depositing on an appropriate substrate or by a method of fine particle recovery with a dust bag. Furthermore, the soot like substances may be recovered from a flow of inert gas by flowing inert gas in a reactive vessel.

The soot like substances obtained by using the apparatus of this embodiment mainly include carbon nano horn assemblies 117 and are recovered as a substance which includes the carbon nano horn assemblies 117 of not less than 50 wt %.

In addition, a shape, diameter size, length, shape of a tip part of a carbon nano-horn, interval between carbon molecules or the carbon nano-horns, and the like which constitute the carbon nano horn assemblies 117 may be controllable in various ways by the irradiation condition or the like of the laser beam 103.

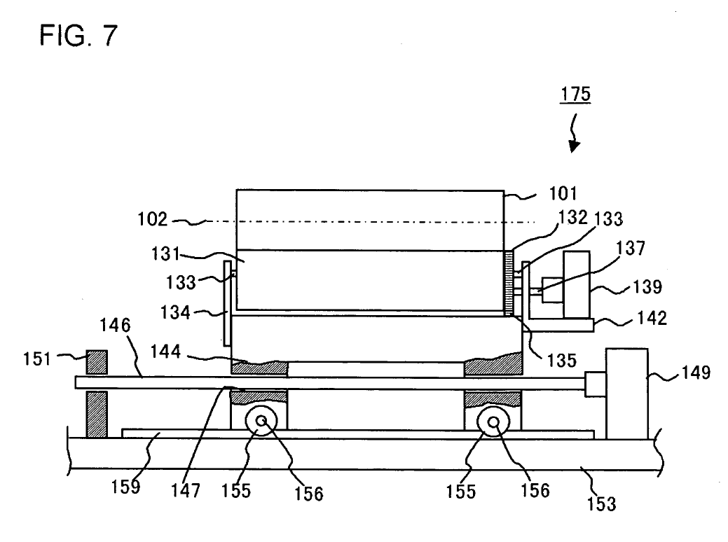

In the apparatus of this embodiment, a gear which rotates the holding roller 131 may be provided as a mechanism for rotating the holding roller 131. FIG. 7 is a view showing a configuration of a target holding movable unit 175 which has such a configuration.

The fundamental constituents of the target holding movable unit 175 shown in FIG. 7 are the same as those of the target holding movable unit 130 shown in FIG. 2; however, a different point is that the target holding movable unit 175 includes a gear 135 which meshes with the interlocking tooth 132 of the holding roller 131 and rotates the holding roller 131 around the rotation axis 133, a rotation axis 137 for the gear 135, and the motor 139 which rotates the gear 135 via the rotation axis 137. The motor 139 is fixed on the rotation axis retainer 142.

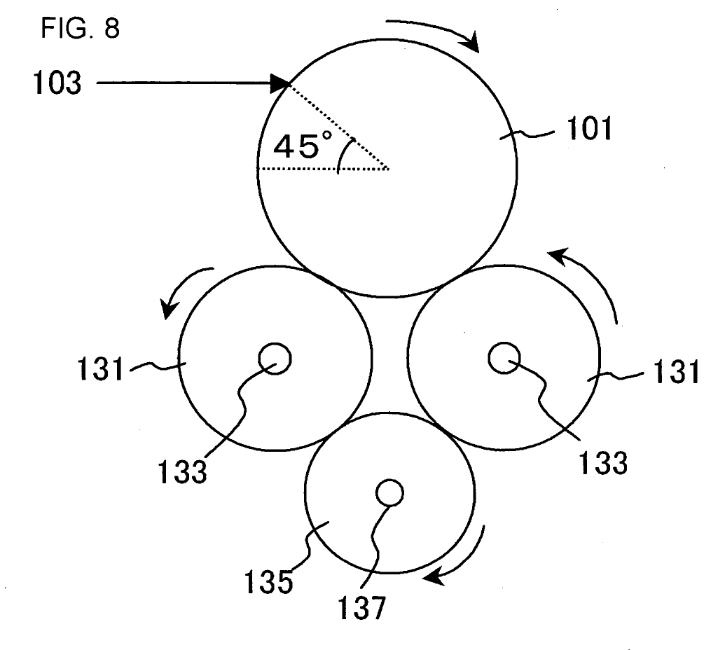

FIG. 8 is a view for explaining rotation of the graphite rod 101 at the target holding movable unit 175. In the target holding movable unit 175, the motor 139 rotates the gear 135, the interlocking tooth 132 is rotated by the rotation of the gear 135, and the holding rollers 131 are rotated around the rotation axes 133.

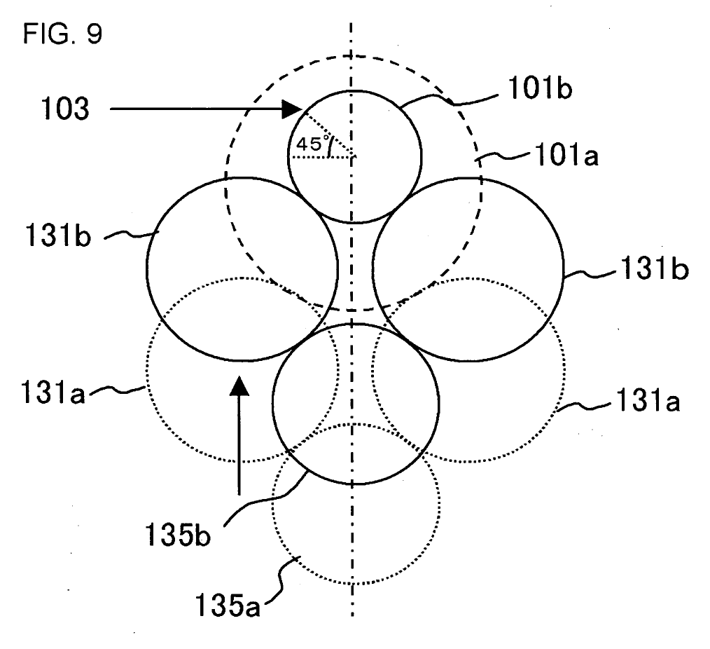

Furthermore, FIG. 9 is a view for explaining position movement of the graphite rod 101 at the target holding unit 175 shown in FIG. 7. As shown in FIG. 9, the irradiation angle of the laser beam 103 to be irradiated to the graphite rod 101 can be maintained constant by moving the holding roller 131 and the gear 135 in up and down direction.

In this embodiment, a configuration which rotates the holding roller 131 is not limited to the aforementioned configurations; for example, a transmission belt, which transmits the rotation of the motor 139, may be provided at one end of the holding roller 131.

Hereinbefore, cases where the carbon nano horn assemblies are manufactured as the nano-carbon are described. A shape, diameter size, length, shape of a tip part of a carbon nano-horn, interval between carbon molecules or the carbon nano-horns, and the like which constitute the carbon nano horn assemblies 117 may be controllable in various ways by the irradiation condition or the like of the laser beam 103.

Furthermore, nano-carbons manufactured using the manufacturing apparatus of this embodiment are not limited to carbon nano horn assemblies.

For example, a carbon nano-tube may be manufactured using the manufacturing apparatus of this embodiment. In the case of manufacturing the carbon nano-tube, it is preferable to adjust an output, spot diameter, and irradiation angle of the laser beam 103 so that the power density of the laser beam 103 at the side surface of the graphite rod 101 is maintained almost constant, for example, to be 50±10 kW/cm². Furthermore, a metal catalyst is added to the graphite rod 101 by not less than 0.0001 wt % to not more than 5 wt %. Metal such as Ni, Co, or the like may be used as a metal catalyst.

Furthermore, in the above-described embodiments, although the case where the graphite rod 101 is used is described as an example, the shape of the graphite target is not limited to a cylindrical shape, but sheet-like shape, rod-like shape, or the like may be used. Even in the case where the graphite target is of sheet-like shape, rod-like shape, or the like, the laser beam 103 can be irradiated to the entire surface of the graphite target by excluding a target grasping part, whereby productivity of the nano-carbon can be improved.

### Embodiment

In this embodiment, carbon nano horn assemblies 117 were manufactured using the apparatus for manufacturing nano-carbon having configurations shown in FIG. 1 to FIG. 6.

A sintered carbon round bar having a diameter of 100 mm, a length of 250 mm, and a weight of 3.7 kg was used as a graphite rod 101; and this bar was placed between two holding rollers 131 of a target holding movable unit 130 in a manufacturing chamber 107. After the inside of the manufacturing chamber 107 was exhausted by depressurizing to a pressure of 10⁻³ Pa, Ar gas was introduced so as to be an atmosphere pressure of 10⁵ Pa. And then, a laser beam 103 was irradiated to a side surface of the graphite rod 101 while rotating the graphite rod 101 at a rotation speed of 6 rpm and horizontally moving at 0.3 mm/sec at the room temperature.

A high power CO₂ laser beam is used as the laser beam, a pulse oscillation was performed under a pulse condition of 1 sec oscillation and 250 msec waiting. Furthermore, an irradiation angle of the laser beam 103 was set to be 45 degrees and a power density at the side surface of the graphite rod 101 was set to be 20 kW/cm²±10 kW/cm².

A soot like substance having approximately 2.8 kg was obtained from the graphite rod 101 having 3.7 kg. The obtained soot like substance was observed by TEM. Furthermore, intensities of 1350 cm⁻¹ and 1590 cm⁻¹ were compared by the Raman spectroscopic method and a yield constant of the carbon nano horn assemblies 117 was calculated.

According to an observation of the obtained soot like substance by a Transmission Electron Microscopy (TEM), the carbon nano horn assemblies 117 was dominantly formed and its particle diameter was within a range from not less than 80 nm to not more than 120 nm. Furthermore, according to calculation of the yield constant of the carbon nano horn assemblies 117 in the entire substances obtained after the light irradiation by the Raman spectroscopic method, every yield constant was a high yield constant of not less than 50% purity.

Consequently, in this embodiment, the graphite rod 101 was held without using a grasping mechanism, thereby irradiating the laser beam 103 to over the entire area of the side surface of the graphite rod 101, whereby the carbon nano horn assemblies 117 with high yield constant could be obtained. Furthermore, it became clear that this process was a continuous process suitable for mass production of the carbon nano horn assemblies 117.

1. An apparatus for manufacturing nano-carbon, comprising:
a target holding unit which has a contact surface being in contact with a surface of a graphite target and movably holds said graphite target by frictional force generated between the contact surface and said surface of said graphite target;
a light source which irradiates light to said surface of said graphite target;
a moving unit which drives said target holding unit so as to move said graphite target held by said a target holding unit relatively to said light source, to move an irradiation position of said light on said surface of said graphite target, and to move said graphite target by the frictional force generated between said contact surface and said surface of said graphite target; and
a recovery unit which recovers nano-carbon obtained from said light irradiation.

2. An apparatus for manufacturing nano-carbon, comprising:
a target holding unit which has a contact surface being in contact with a surface of a cylindrical graphite target and movably holds said graphite target by frictional force generated between the contact surface and said surface of said graphite target;
a light source which irradiates light to said surface of said graphite target;
a moving unit which drives said target holding unit so as to move said graphite target held by said target holding unit relatively to said light source, to move an irradiation position of said light on said surface of said graphite target, and to rotate said graphite target around a central axis by the frictional force generated between said contact surface and said surface of said graphite target; and
a recovery unit which recovers nano-carbon obtained from said light irradiation.

3. The apparatus for manufacturing nano-carbon as set forth in claim 2,
wherein said target holding unit has two cylindrical rollers which have rotation axes substantially parallel to said central axis of said graphite target and hold said graphite target between positions parallely disposed each other; and
said moving unit rotates said graphite target around said central axis by said frictional force generated between said contact surface of said roller and said surface of said graphite target by rotating said roller around said rotation axis.

4. The apparatus for manufacturing nano-carbon as set forth in any one of claims 1 to 3,
wherein said moving unit drives said target holding unit so that the irradiation position of said light irradiated to said surface of said graphite target covers over almost the entire area of said surface of said graphite target.

5. The apparatus for manufacturing nano-carbon as set forth in any one of claims 1 to 3,
wherein said moving unit is configured so as to move said irradiation position while maintaining an irradiation angle of said light substantially constant, at the irradiation position of said light on said surface of said graphite target.

6. The apparatus for manufacturing nano-carbon as set forth in any one of claims 1 to 3,
wherein said target holding unit comprises one of stainless steel or ceramics, alternatively a metal deposited with carbon on a surface.

7. The apparatus for manufacturing nano-carbon as set forth in any one of claims 1 to 3,
wherein said nano-carbon is carbon nano horn assemblies.

8. A method of manufacturing nano-carbon, comprising:
irradiating light to a surface of a graphite target; and
recovering nano-carbon generated in said irradiating light,
wherein said irradiating light includes irradiating said light while holding said graphite target by a contact surface disposed in contact with said surface while moving said graphite target by frictional force between said surface and said contact surface.

9. A method of manufacturing nano-carbon, comprising:
irradiating light to a surface of a cylindrical graphite target while rotating said graphite target around a central axis; and
recovering nano-carbon generated in said irradiating light,
wherein said irradiating light includes irradiating said light while holding said graphite target by a contact surface disposed in contact with said surface and while rotating said graphite target around the central axis by frictional force between said surface and said contact surface.

10. The method of manufacturing nano-carbon as set forth in claim 9,
wherein said contact surface is disposed in contact with a side surface of said graphite target.

11. The method of manufacturing nano-carbon as set forth in any one of claims 8 to 10,
wherein, in said irradiating light to the surface of said graphite target, said light is irradiated so as to cover over almost the entire area of said surface of said graphite target while moving the irradiation position of said light.

12. The method of manufacturing nano-carbon as set forth in any one of claims 8 to 10,
wherein, in said irradiating light, said light is irradiated so that the irradiation angle of said light to said surface of said graphite target is substantially constant.

13. The method of manufacturing nano-carbon as set forth in any one of claims 8 to 10,
wherein said irradiating light includes irradiating a laser beam.

14. The method of manufacturing nano-carbon as set forth in any one of claims 8 to 10,
wherein said recovering nano-carbon includes recovering carbon nano horn assemblies.
